(19) United States
(12) Patent Application Publication
(10) Pub. No.: US 2025/0284167 A1
(43) Pub. Date: Sep. 11, 2025

(54) ELECTROCHROMIC ELEMENT AND METHOD FOR MANUFACTURING THE SAME

(71) Applicant: CANON KABUSHIKI KAISHA, Tokyo (JP)

(72) Inventor: KAZUYA MIYAZAKI, Tokyo (JP)

(21) Appl. No.: 19/073,712

(22) Filed: Mar. 7, 2025

(30) Foreign Application Priority Data
Mar. 11, 2024 (JP) 2024-037053

(51) Int. Cl. G02F 1/1514; G02F 1/155; G02F 1/163

(52) U.S. Cl. CPC G02F 1/1514; G02F 1/155; G02F 1/163

(57) ABSTRACT

An electrochromic element is fabricated by preparing an electrochromic gel containing a crosslinked product of a dimer or higher polymer of a compound having a side chain containing a tertiary amine or a cyclic imine, placing the electrochromic gel on a first electrode with a seal pattern, reducing the pressure in a region surrounded by the seal pattern, and bonding a second electrode to the first electrode.

### BACKGROUND OF THE INVENTION

### Technical Field

The present disclosure relates to an electrochromic element and a method for manufacturing the electrochromic element.

### Description of the Related Art

An electrochromic (hereinafter also abbreviated to EC) element is an active optical element that includes a pair of electrodes and an EC layer between the electrodes. The EC element adjusts the hue or amount of light in the visible light region as a voltage is applied between the pair of electrodes to oxidize or reduce a compound in the EC layer.

EC elements have already been widely used in automobile anti-glare mirrors and airplane dimming windows. However, in view of further expanding the use of EC elements for consumer-grade products in the future, a simpler structure and manufacturing method are desirable to provide them at a lower cost. In recent years, the use of dimming elements in combination with watch-type or glasses-type wearable terminal devices has increased, and accordingly, dimming elements functioning on terminal devices are required to be highly reliable.

The vacuum bonding method, which has been increasingly used in recent years in the manufacture of EC elements, requires fewer process steps than the conventional vacuum injection method. In addition, this method is advantageous for increasing the area of elements and can be used with high-viscosity solutions, consequently being used more frequently. International Publication No. 2011/018916, which provides a method for manufacturing a display panel using an EC element or electrodeposition element (hereinafter referred to as “ED” element) by vacuum bonding, discloses a technique to reduce the surface area where the dropping solution comes into contact with the vacuum atmosphere to avoid display defects, such as uneven filling and marks from solution drops due to solvent evaporation.

Also, in order to achieve high reliability, the EC layer is gelled, semi-solidified, or solidified to prevent solution leakage when the element is broken. Japanese Patent Laid-Open No. 2019-91053 discloses a technique in which an electrochromic gelling medium is injected into an element using a vacuum injection method, followed by a crosslinking reaction for gelling or film formation.

However, the method disclosed in International Publication No. 2011/018916 above, which is a technique of using an ungelled EC medium for fabricating EC elements by vacuum bonding, does not address new disadvantages in element process and performance caused by gelling agents. The technique disclosed in Japanese Patent Laid-Open No. 2019-91053 above is limited to vacuum injection in the process for fabricating the element. Also, the EC gel is formed by crosslinking polymerization of an EC compound with two or more hydroxy groups at the ends and a compound with two or more isocyanate groups in a polymer medium, so that the EC molecules are arranged in a branched form in the polymer network, making the substance difficult to move. Thus, there is room for improvement in response.

### SUMMARY OF THE INVENTION

Accordingly, the present disclosure provides an electrochromic element that can be fabricated at a low cost while improving the response and achieving high reliability.

A first aspect of the present disclosure provides an electrochromic element including a first electrode, a second electrode, and an electrochromic layer disposed between the first electrode and the second electrode and containing at least one electrochromic compound.

The electrochromic layer is a gel layer containing a crosslinked product of a dimer or higher polymer of a compound having a side chain containing a tertiary amine or a cyclic imine.

A second aspect of the present disclosure provides a method for manufacturing an electrochromic element that includes a first electrode, a second electrode, and an electrochromic layer disposed between the first electrode and the second electrode and containing at least one electrochromic compound. The method includes preparing an electrochromic gel containing at least one electrochromic compound, a solvent, and a crosslinked product of a dimer or higher polymer of a compound having a side chain containing a tertiary amine or a cyclic imine, forming a seal pattern surrounding a region to be filled with the electrochromic gel on the first electrode, placing the electrochromic gel in the region surrounded by the seal pattern on the first electrode and then reducing the pressure in the region surrounded by the seal pattern, and bonding the first electrode and the second electrode together under the reduced pressure.

Further features of the present disclosure will become apparent from the following description of exemplary embodiments with reference to the attached drawings.

### BRIEF DESCRIPTION OF THE DRAWINGS

FIG. 1 is a schematic sectional view of an EC element according to an embodiment of the present disclosure.

FIGS. 2A to 2C are schematic sectional views illustrating a method according to an embodiment of the present disclosure for manufacturing an EC element using a vacuum bonding method.

FIG. 3 is a plot representing changes in rotational torque during the gelation of an EC gel.

FIG. 4 is a schematic diagram of an example of a drive unit including an EC element according to an embodiment of the present disclosure.

FIG. 5A is a schematic diagram of an example of an imaging device in which an optical filter is disposed in a lens unit.

FIG. 5B is a schematic diagram of an example of an imaging device in which an optical filter is disposed in an imaging unit.

FIG. 6A is a schematic diagram of a window using an EC element according to an embodiment of the present disclosure.

FIG. 6B is a schematic sectional view of a window using an EC element according to an embodiment of the present disclosure, taken in the thickness direction.

### DESCRIPTION OF THE EMBODIMENTS

Exemplary embodiments of the electrochromic element (EC element) disclosed herein will be described in detail below with reference to the drawings. The configuration, relative positions, and the like described herein are not intended to limit the scope of the present disclosure unless otherwise described.

### EC Element

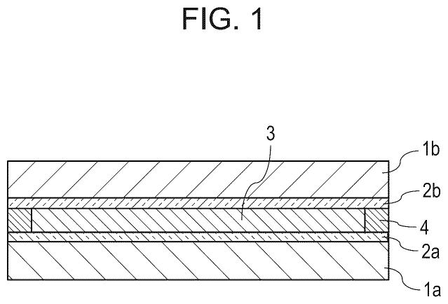

The configuration of the EC element disclosed herein will first be described with reference to FIG. 1. FIG. 1 is a schematic sectional view of an EC element according to an embodiment of the present disclosure taken in the thickness direction. In FIG. 1, reference numerals 1a and 1b denote a first substrate and a second substrate, respectively, and a first electrode 2a and a second electrode 2b are each disposed on one side (on the inner side of the element) of the corresponding substrate. Reference numeral 3 denotes an electrochromic layer (EC layer), and reference numeral 4 denotes a seal that serves to join the first substrate 1a and the second substrate 1b together and to protect the EC layer 3 from the surrounding environment (oxygen and water).

The first and second substrates 1a and 1b are made of a highly transparent, heat-resistant, and chemically stable electrical insulator, such as glass or resin. Examples of the glass include optical glass, quartz glass, white glass, soda-lime glass, borosilicate glass, non-alkali glass, and chemically reinforced glass. In some embodiments, non-alkali glass is used from the viewpoint of transparency and durability. Examples of the resin include polycarbonate (PC), polymethyl methacrylate (PMMA), polyethylene terephthalate (PET), and transparent polyimide (PI). Such a resin substrate may be provided with a hard coating layer on its surface to enhance scratch resistance.

The first and second electrodes 2a and 2b are both transparent, and examples of the material include indium tin oxide (ITO), fluorine-doped tin oxide (FTO), tin oxide (NESA), indium zinc oxide (IZO), and graphene. Conductive polymers whose electrical conductivity is increased by doping or the like may also be used, and examples include polyaniline, polypyrrole, polythiophene, polyacetylene, poly(para-phenylene), and complexes of polyethylenedioxythiophene (PEDOT) and poly(styrenesulfonic acid).

In order to ensure the reliability of the EC element, the EC layer 3 is a gel layer made of an electrochromic gel (EC gel) containing an organic solvent in which an electrochromic compound (EC compound) is dissolved.

The EC compound may be an organic compound and may be an anodic compound that is changed from a transparent state to a colored state by an oxidation reaction or a cathodic compound that is changed from a transparent state to a colored state by a reduction reaction. Both an anodic compound and a cathodic compound may also be used. Using an anodic compound and a cathodic compound together increases coloring efficiency for current. In the description presented herein, an element containing both an anodic compound and a cathodic compound is referred to as a complementary EC element. Anodic compounds may also be referred to as anodic materials, and cathodic compounds may also be referred to as cathodic materials.

When a complementary EC element operates, an oxidation reaction occurs at one electrode to draw electrons from the EC compound, and at the other electrode, a reduction reaction occurs to give electrons to the EC compound. The oxidation reaction may produce radical cations from neutral molecules. The reduction reaction may produce radical anions from neutral molecules or produce radical cations from dicationic molecules. If the EC compound is colored at both electrodes 2a and 2b and a large change in optical density is required between the electrodes, a complementary EC element may be used.

Examples of organic EC compounds include electrically conductive polymers, such as polythiophene and polyaniline, and low-molecular-weight organic compounds, such as viologen-based compounds, anthraquinone-based compounds, oligothiophene derivatives, and phenazine derivatives.

In some embodiments, the EC layer 3 contains at least one anodic EC compound and at least one cathodic EC compound to provide a complementary EC element.

When the EC layer 3 contains a plurality of EC compounds, the EC compounds may be selected so that the difference in redox potential between the compounds is small. When a plurality of EC compounds is used, a total of four or more EC compounds including anodic and cathodic compounds may be used, and the EC element disclosed herein may contain five or more EC compounds. When a plurality of EC compounds is used, a plurality of anodic materials may exhibit redox potentials within 60 mV, and a plurality of cathodic materials may exhibit redox potentials within 60 mV. When a plurality of EC compounds is used, the EC compounds may include a compound having an absorption peak at a wavelength of 400 nm to 500 nm, a compound having an absorption peak at a wavelength of 500 nm to 650 nm, and a compound having an absorption peak at a wavelength of 650 nm or more. An absorption peak is defined as a peak having a half width of 20 nm or more. When absorbing light, the material may be in an oxidized state, a reduced state, or a neutral state.

The EC layer 3 may contain an electrolyte. The electrolyte is not limited, provided that it is an ionically dissociable salt exhibiting high solubility in solvents or, when it is solid, exhibiting high compatibility with solvents. In some embodiments, electron-donating electrolytes are used. These electrolytes may also be referred to as a supporting electrolyte. Examples of the electrolyte include various inorganic ion salts, such as alkali metal salts and alkaline-earth metal salts, and various quaternary ammonium salts and cyclic quaternary ammonium salts.

Specific examples of the electrolyte include alkali metal (Li, Na, or K) salts, such as LiClO₄, LiSCN, LiBF₄, LiAsF₆, LiCF₃SO₃, LiPF₆, LiI, NaI, NaSCN, NaClO₄, NaBF₄, NaAsF₆, KSCN, and KCl; and quaternary ammonium salts and cyclic quaternary ammonium salts, such as (CH₃)₄NBF₄, (C₂H₅)₄NBF₄, (n-C₄H₉)₄NBF₄, (n-C₄H₉)₄NPF₆, (C₂H₅)₄NBr, (C₂H₅)₄NClO₄, and (n-C₄H₉)₄NClO₄.

The solvent to dissolve the EC compound and electrolyte is not limited, provided that it can dissolve the EC compound and electrolyte, but in some embodiments, it is a polar solvent. Specific examples of the solvent include water and organic polar solvents, such as methanol, ethanol, propylene carbonate, ethylene carbonate, dimethyl sulfoxide, dimethoxyethane, γ-butyrolactone, γ-valerolactone, sulfolane, dimethylformamide, dimethoxyethane, tetrahydrofuran, acetonitrile, propionitrile, 3-methoxypropionitrile, benzonitrile, dimethylacetamide, methylpyrrolidinone, and dioxolane.

The EC layer 3 may contain a spacer that fixes the distance between the first and second electrodes 2a and 2b. The spacer may be an inorganic material, such as silica beads or glass fibers, or an organic material, such as polydivinylbenzene, polyimide, polytetrafluoroethylene, fluorocarbon rubber, or epoxy resin.

The EC layer 3 disclosed herein is a gel layer containing a crosslinked product of a dimer or higher polymer of a compound having a side chain containing a tertiary amine or a cyclic imine. The polymer of a compound having a side chain containing a tertiary amine may be, for example, poly(dimethylaminoethyl methacrylate), and the polymer of a compound having a side chain containing a cyclic imine may be, for example, poly(4-vinylpyridine). However, the EC layer 3 is not limited to these polymers in the embodiments of the present disclosure. In addition to the above-described polymer, the EC layer may contain polyacrylonitrile, carboxymethyl cellulose, pullulan-based polymer, polyvinyl chloride, polyethylene oxide, polypropylene oxide, polyurethane, polyacrylate, polymethacrylate, polyamide, polyacrylamide, polyester, polyvinylpyridine, and Nafion (registered trademark).

The crosslinking agent to crosslink the dimer or higher polymer may be a compound with two or more electrophilic substituents, such as N,N,N′,N′-tetra(trifluoromethanesulfonyl)-hexane-1,6-diamine or N,N,N′,N′-tetra(trifluoromethanesulfonyl)-dodecane-1,12-diamine. The use of the above-described specific dimer or higher polymer and the above-described crosslinking agent enables the EC layer 3 to be an ionic chemical gel, which can provide an EC element with higher reliability and better responsivity than a physical gel, which liquefies at or above the transition temperature.

The seal 4 may join the first and second substrates 1a and 1b having the respective first and second electrodes 2a and 2b to each other and protect the EC layer 3 from the surrounding environment (oxygen and water). Also, since the seal 4 directly contacts the electrically active EC layer 3, it is required to have no reactivity with the EC compound and low affinity with the solvent dissolving the EC compound. Accordingly, the seal 4 may be made of a one-component solvent-free acrylic or epoxy resin or the like. The seal 4 may be made of a single material or may be formed in a multilayer structure with different functions using a plurality of materials.

Furthermore, a bus line (not shown) may be provided around the seal 4 to ensure uniform voltage application across the entire dimming region. The bus line may be made of a low-resistance metal material, for example, a thin-film or the like of silver, palladium, copper, aluminum, silver-palladium-copper alloy (APC), or aluminum-neodymium alloy. The bus line may be formed on the pair of transparent electrodes in such a manner as to surround the dimming region. Additionally, a plurality of power supply portions may be provided for each bus line to prevent voltage drops in the bus line.

### Method for Manufacturing EC Element

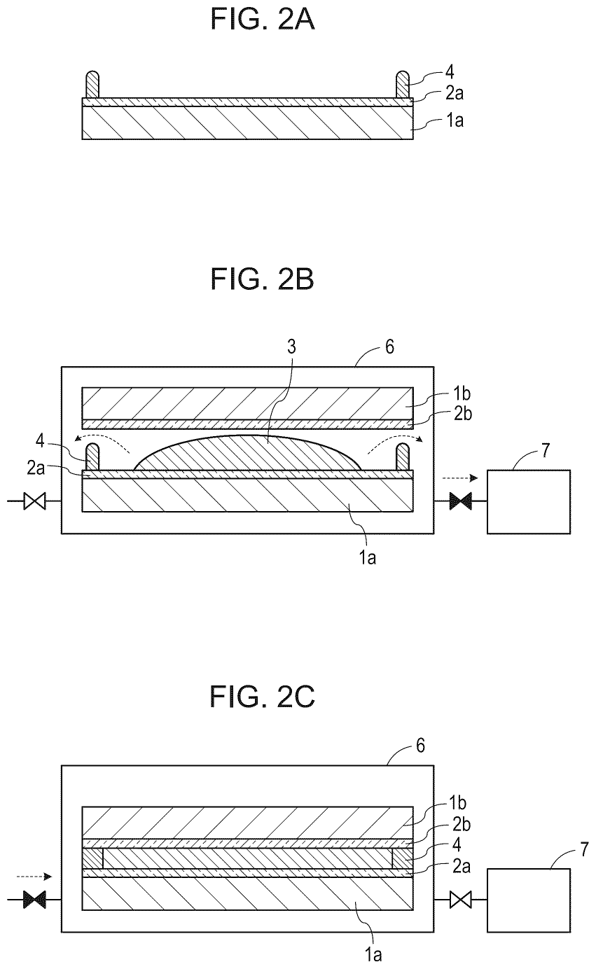

A method for manufacturing the EC element disclosed herein will now be described with reference to FIGS. 2A to 2C. FIGS. 2A to 2C are schematic sectional views taken in the thickness direction, illustrating a process of manufacturing the EC element depicted in FIG. 1.

The EC element disclosed herein may be fabricated using a vacuum bonding method. FIGS. 2A to 2C illustrate a method according to an embodiment of the present disclosure for manufacturing the EC element using a vacuum bonding method.
(1) EC gel preparation: An EC gel containing at least one EC compound, a solvent, a crosslinked product of a dimer or higher polymer of a compound having a side chain containing a tertiary amine or a cyclic imine is prepared. The EC gel is obtained by heating an EC gelling solution containing the EC compound, the solvent, the dimer or higher polymer of a compound having a side chain containing a tertiary amine or a cyclic imine, and a crosslinking agent. The heating temperature and heating time for gelling the EC gelling solution are selected as appropriate depending on the EC compound, solvent, polymer, and crosslinking agent to be used and the desired degree of gelation.
(2) Seal pattern formation: The seal 4 is formed on the first substrate 1a having the first electrode 2a so as to surround the dimming region by drawing with a dispenser or the like (FIG. 2A).
(3) Pressure reduction: The electrode substrate (on the lower side) prepared in (2) and the counter electrode substrate (on the upper side) are set in a vacuum bonding apparatus, and an appropriate amount of EC gel 3, which has been gelled in advance, is placed on the lower electrode substrate. The pressure in the vacuum chamber 6 is reduced to about 100 Pa (FIG. 2B), and then UV light is applied to cure the seal, with the upper and lower electrode substrates brought close together to the distance defined by the spacer. At this time, a shielding mask may be used to prevent the gel layer from being exposed to UV light.
(4) Completion of bonding: The chamber 6 is ventilated with nitrogen gas or dry air (FIG. 2C), and the EC element is removed. If the seal used requires additional curing by heat, the seal is subsequently heated in an oven. Finally, a pair of terminals are connected to the respective electrodes 2a and 2b to complete the EC element.

In this process, in which the EC gel that has been gelled in advance is placed on the electrode 2a before bonding, display defects such as marks from solution drops or property degradation may occur depending on the degree of gelation of the EC gel, in which case particular care is required. Accordingly, a study was conducted to quantify the degree of gelation of the EC gel and to identify the factors causing display defects.

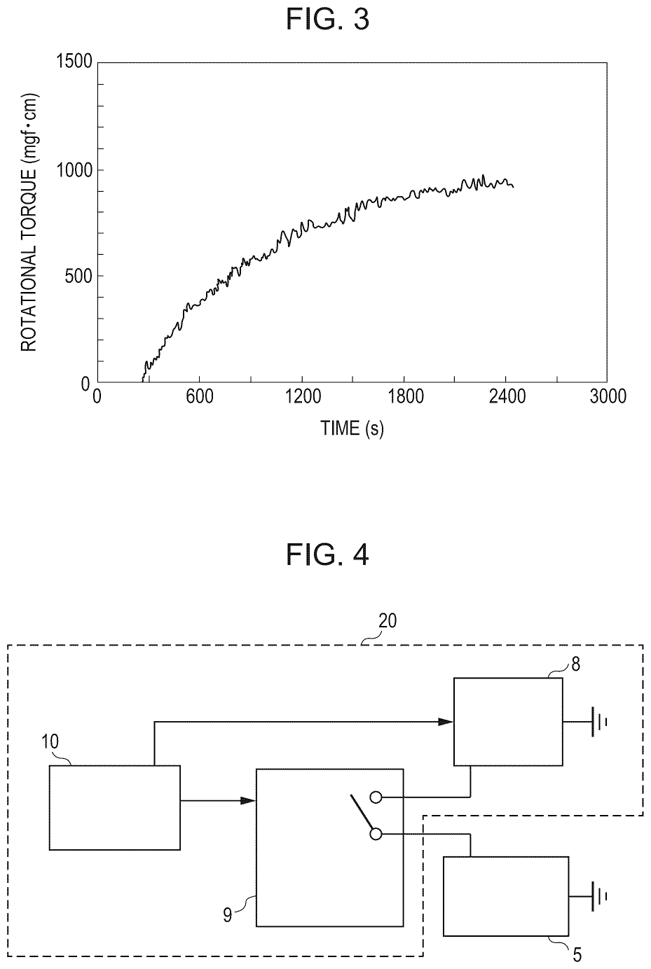

FIG. 3 illustrates the gelling process of an EC gel at 90° C., quantified by rotational torque using an automatic apparatus for gelation time method A specified in JIS K 6910:2007. FIG. 3 shows that at 90° C., the EC gel starts to gel after about 5 minutes and almost completes gelling when the rotational torque reaches 900 mgf·cm to 1000 mgf·cm after about 30 minutes. Accordingly, EC gels whose degree of gelation was varied by heating time were prepared, and EC elements were fabricated by the vacuum bonding method using these EC gels and were evaluated for their properties. As a result, EC elements fabricated using gels with a low degree of gelation exhibited significant display defects and degradation in properties, whereas EC elements fabricated using gels with a high degree of gelation (500 mgf·cm or more in rotational torque) exhibited improvements in terms of display defects and degradation in properties.

In addition, when the electrodes 2a and 2b of the EC element had hydrophilic surfaces, the display defects and degradation in properties were particularly significant. This suggests that the polymer of a compound having a side chain containing a tertiary amine or a cyclic imine in the EC gelling solution adsorbs to or coordinates with the surfaces of the electrodes and inhibits the EC reaction. Thus, it may be appropriate to use in the vacuum bonding method an EC gel exhibiting a rotational torque of 500 mgf·cm or more as measured using an automatic apparatus for gelation time method A specified in JIS K 6910:2007.

### Applications of EC Element

The EC element disclosed herein can be used in optical filters, lens units, imaging devices, window components, and the like.

### Optical Filter

An optical filter according to an embodiment includes an EC element and an active element connected to the EC element. The active element drives the EC element and adjusts the amount of light passing through the EC element. The active element may be a transistor. The transistor may contain a semiconductor material, such as InGaZnO, in the active region.

The optical filter according to the embodiment includes the EC element disclosed herein and a drive unit connected to the EC element. FIG. 4 is a schematic diagram illustrating an example of a drive unit 20 for an EC element and an EC element 5 driven by the drive unit 20. In the illustrated embodiment, the drive unit 20 includes a driving power supply 8, a resistor switch 9, and a controller 10.

The driving power supply 8 applies a voltage (driving voltage) required for the electrochemical reaction of the EC material in the EC layer to the EC element 5. In some embodiments, the driving voltage is constant. A constant voltage may be applied because when the EC material is composed of a plurality of materials, the absorption spectrum may change due to the differences in redox potential and molar absorption coefficient between the materials. The driving power supply 8 starts to apply a voltage or maintains the application of the voltage in response to a signal from the controller 10, and in the period when the optical transmittance of the EC element 5 is controlled, the application of a constant voltage is maintained.

The controller 10 controls the transmittance of the EC element 5 in a way suitable for the EC element 5. More specifically, conditions determined in advance for a desired set value of the transmittance may be input to the EC element 5, or conditions to meet the set value of the transmittance may be selected and input according to the comparison between the set value of the transmittance and the transmittance of the EC element 5. Examples of parameters to be varied include voltage, current, and duty ratio. The controller 10 can vary the voltage, current, or duty ratio to change the color density of the EC element 5.

In the embodiment disclosed herein, a known technique can be used to vary voltage, vary current, or modulate the pulse width. Also, the pulse width may be modulated as described below.

The resistor switch 9 switches between a resistor R1 and a resistor R2 with higher resistance than the resistor R1 (both not shown) and connects either resistor in series in a closed circuit including the driving power supply 8 and the EC element 5. The resistance of the resistor R1 may be lower than at least the highest impedance in the closed circuit of the element and is, for example, 10Ω or less. The resistance of the resistor R2 may be higher than the highest impedance in the closed circuit of the element and is, for example, 1 MΩ or more. The resistor R2 may be air. In this instance, the closed circuit is open in strict meaning but can be considered closed, provided that air is considered the resistor R2.

The controller 10 transmits switching signals to the resistor switch 9 to control the switching between the resistors R1 and R2. Alternatively, the controller 10 may generate PWM signals using a comparator or the like without a resistor switch.

### Lens Unit

A lens unit according to an embodiment of the present disclosure includes an imaging optical system including a plurality of lenses, and an optical filter including the EC element disclosed herein. The optical filter may be disposed between the plurality of lenses or outside the lenses. In some embodiments, the optical filter is disposed on the optical axis of the lenses.

### Imaging Device

An imaging device according to an embodiment of the present disclosure includes an optical filter and a light-receiving element configured to receive light passing through the optical filter. Specific examples of the imaging device include cameras, video cameras, and camera-equipped phones. The imaging device may be configured such that a main body including the light-receiving element is separable from a lens unit including one or more lenses. In an embodiment in which the main body of the imaging device is separable from the lens unit, an optical filter apart from the imaging device may be used for imaging. Such a structure is also within the scope of the present disclosure. In this instance, the optical filter may be disposed outside the lens unit, between the lens unit and the light-receiving element, or between the lenses (when the lens unit includes a plurality of lenses).

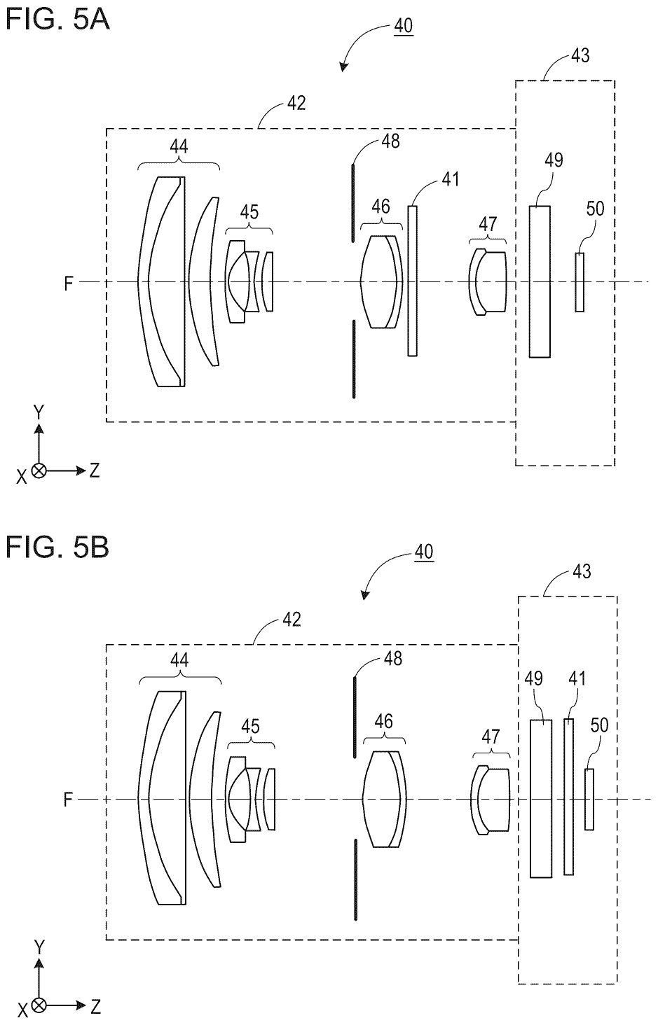

FIG. 5A is a schematic diagram of an example of an imaging device in which an optical filter is disposed in a lens unit, and FIG. 5B is a schematic diagram of an example of an imaging device in which an optical filter is disposed in an imaging unit.

The imaging device 40 includes a lens unit 42 and an imaging unit 43. The lens unit 42 includes an optical filter 41, and an imaging optical system including a plurality of lenses or lens sets. The optical filter 41 is the optical filter disclosed herein as described above.

The lens unit 42, for example, in FIG. 5A, is a rear focusing zoom lens that focuses behind a diaphragm. The lens unit 42 includes four lens sets arranged in the following order from the object to be imaged: a first lens set 44 having a positive refractive power, a second lens set 45 having a negative refractive power, a third lens set 46 having a positive refractive power, and a fourth lens set 47 having a positive refractive power. The distance between the second lens set 45 and the third lens set 46 is varied to vary magnification, and some of the lenses of the fourth lens set 47 are moved for focusing.

For example, the lens unit 42 includes an aperture diaphragm 48 between the second lens set 45 and the third lens set 46, and the optical filter 41 between the third lens set 46 and the fourth lens set 47. The lens unit is arranged so that light entering the lens unit passes through the lens sets 44 to 47, the diaphragm 48, and the optical filter 41 to allow the aperture diaphragm 48 and the optical filter 41 to adjust the amount of light. The lens unit 42 is removably connected to the imaging unit 43 with a mounting member (not shown).

Although in the present embodiment, the optical filter 41 is disposed between the third lens set 46 and the fourth lens set 47 in the lens unit 42, the imaging device 40 is not limited to this configuration. For example, the optical filter 41 may be disposed in front of the aperture diaphragm 48 (on the imaging subject side), behind the aperture diaphragm (on the imaging unit 43 side), in front of or behind any of the first to fourth lens sets 44 to 47, or between any two of the lens sets 44 to 47. Placing the optical filter 41 at a position where light converges is beneficial, for example, for reducing the area of the optical filter 41.

The configuration of the lens unit 42 is also not limited to that described above and may be selected as appropriate. The lens unit may be of a type other than the rear focusing type and may be, for example, of an inner focusing type that focuses on a position in front of the diaphragm or any other type. Also, a special lens, such as a fisheye lens or a microlens, as well as a zoom lens may be selected as appropriate.

The imaging unit 43 includes a glass block 49 and a light-receiving element 50. The glass block 49 may be a low-pass filter, a face plate, or a color filter. The light-receiving element 50 is a sensor that receives light passing through the lens unit 42 and may be an imaging element, such as a CCD or a CMOS. Alternatively, the light-receiving element 50 may be a light sensor such as a photodiode, and an element or device capable of obtaining and outputting information such as light intensity or wavelength may be used as appropriate.

When the optical filter 41 is incorporated in the lens unit 42, as depicted in FIG. 5A, the drive unit may be disposed within or outside the lens unit 42. When disposed outside the lens unit 42, the drive unit is connected for drive control to the EC element in the lens unit 42 with a wire.

In the above-described imaging device 40, the optical filter 41 is located inside the lens unit 42. However, the configuration is not limited to that in this embodiment, provided that the optical filter 41 is located at an appropriate position inside the imaging device 40 so that the light-receiving element 50 can receive light passing through the optical filter 41.

For example, the imaging unit 43 may have the optical filter 41, as depicted in FIG. 5B. FIG. 5B is a schematic diagram of another example of the imaging device disclosed herein, illustrating a configuration in which the optical filter 41 is located in the imaging unit 43. In FIG. 5B, the optical filter 41 is located, for example, directly in front of the light-receiving element 50. In a configuration in which the imaging device itself incorporates the optical filter 41, the lens unit 42 to be connected need not include the optical filter 41. Accordingly, a dimmable imaging device can be configured using an existing lens unit 42.

The imaging device 40 disclosed herein can be applied to products including a combination of a light-receiving element and the function of adjusting the amount of light. For example, the imaging device may be a camera, a digital camera, a video camera, or a digital video camera and can also be used in products with built-in imaging devices, such as mobile phones, smartphones, PCs, and tablet computers.

According to the imaging device 40 disclosed herein, the optical filter 41 can be used as a dimmer member to enable a single filter to vary the dimming level as appropriate. This is beneficial for reducing the number of components and saving space.

### Window

A window according to an embodiment of the present disclosure includes an EC element and an active element connected to the EC element. The active element drives the EC element and adjusts the amount of light passing through the EC element. The active element may be a transistor. The transistor may contain a semiconductor material, such as InGaZnO, in the active region. The window disclosed herein may be called a variable transmittance window.

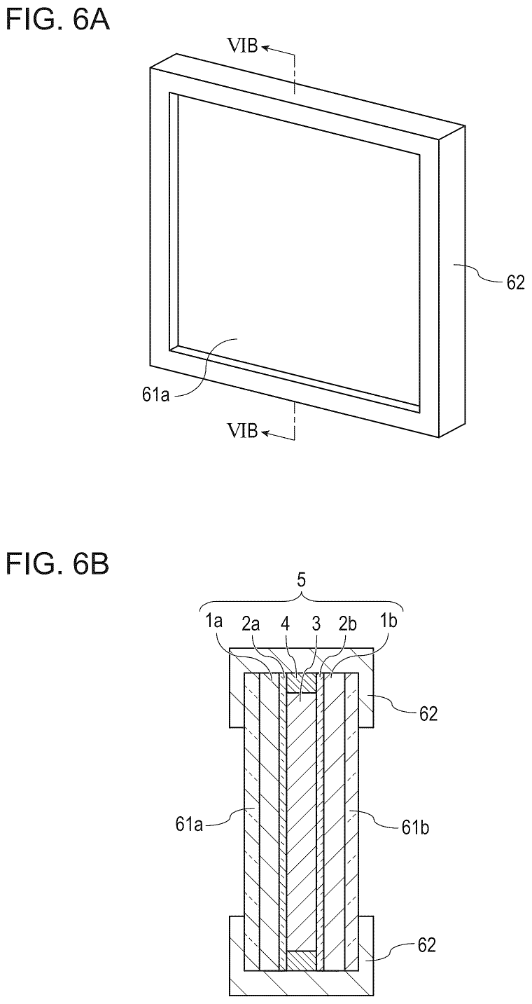

FIG. 6A is a schematic diagram of a dimming window used as a window component including the EC element disclosed herein, and FIG. 6B is a schematic sectional view taken along line VIB-VIB at the center of FIG. 6A. The dimming window disclosed herein includes an EC element 5, transparent plates 61a and 61b holding the EC element 5 therebetween, and a frame 62 surrounding and integrating the entire structure. The EC element 5 used in the present embodiment has the structure depicted in FIG. 1 and is provided with a drive unit (not shown). The drive unit may be integrated with the frame 62 or located outside the frame 62 and connected to the EC element 5 with a wire.

The material of the transparent plates 61a and 61b is not limited, provided that the material has high light transmittance. In some embodiments, glass is used in view of use as a window. The frame 62 may be made of any material, and a structure that covers at least a portion of the EC element 5 and that has an integrated form in general may be considered the frame 62. In the embodiment illustrated in FIGS. 6A and 6B, the EC element 5 is a component independent of the transparent plates 61a and 61b. However, in another embodiment, the substrates 1a and 1b of the EC element 5 may be considered the transparent plates 61a and 61b.

The dimming window may be used, for example, to adjust the amount of sunlight entering a room during the daytime. The dimming window may also be used to adjust the amount of heat as well as the amount of sunlight and may therefore be used to control the brightness and temperature in a room. Also, the dimming window may be used as a shutter to block views from the outside to the interior. Such a dimming window may be used as a window for vehicles such as cars, trains, airplanes, and ships, as well as a glass window for buildings.

Thus, the EC element disclosed herein can be used in optical filters, lens units, imaging devices, window components, and the like.

The EC element may be provided with a reflection member in one of the light paths to function as an electrochromic mirror. The EC mirror may be provided as an anti-glare mirror for vehicles.

The EC mirror may include an EC element and a reflection member disposed inside or outside the EC element. Having a reflection member inside the EC element implies that the EC element has a reflective electrode. Having a reflection member outside the EC element implies that the reflection member is disposed in contact with an electrode of the EC element or with another transparent member between the reflection member and the electrode.

### EXAMPLES

### Example 1

### Preparation of EC Gel

Four EC compounds presented below were dissolved in a solvent, i.e., propylene carbonate, and gap control particles with a particle size of 50 μm (Micropearl SP-250, produced by Sekisui Chemical Co., Ltd.) were added. Then, poly(4-vinylpyridine) as the polymer of a compound having a side chain containing a cyclic imine and N,N,N′,N′-tetra(trifluoromethanesulfonyl)-hexane-1,6-diamine, which has two or more electrophilic substituents, as the crosslinking agent were added, followed by heating at 90° C. for about 15 minutes for acceleration of gelling. In a measurement using an automatic apparatus (MADOKA, manufactured by Cyber Co., Ltd.) for gelation time method A specified in JIS K 6910:2007, the resulting EC gel was characterized as exhibiting a rotational torque of 572 mgf·cm.

### Anodic EC Compounds:

3-(2-Isopropoxy-6-methoxyphenyl)-1,5,10-trimethyl-8-phenoxy-5,10-dihydrophenazine
5,10-Diisopropyl-2-(3-methoxyphenoxy)-7-methyl-5,10-dihydrophenazine Cathodic EC Compounds:
9,9-Dimethyl-2,7-bis(4,4,4-trifluorobutyl)-9H-cyclopenta[1,2-c:4,3-c′]dipyridinium bis[bis(trifluoromethanesulfonyl)imide]
1,1′-Bis(4-tert-butyl)phenyl-3-methyl-4,4′-dipyridinium bis[bis(trifluoromethanesulfonyl)imide]

### Fabrication of EC Element

A UV-curable acrylic seal (3035B produced by ThreeBond) was applied onto an ITO glass substrate with a sheet resistance of 10 Ω/sq to draw a pattern surrounding a rectangular dimming region, using a dispenser.

The ITO glass substrate with the seal drawn thereon and a counter ITO glass substrate with the same specifications were set in a vacuum bonding apparatus, and an appropriate amount of the EC gel was placed in the dimming region on the ITO glass substrate with the seal drawn thereon (on the lower side). After the vacuum bonding apparatus was evacuated to 100 Pa, the pair of ITO glass substrates were bonded together, and the seal was cured by UV irradiation. The element was removed from the vacuum bonding apparatus, and a pair of terminals were connected to the respective ITO electrodes to complete an EC element.

### Example 2

An EC gelling solution was prepared in the same manner as in Example 1, except that the heating time for the EC gelling solution was increased to about 30 minutes. The resulting EC gel was characterized as exhibiting a rotational torque of 880 mgf·cm. An EC element was fabricated using this EC gel in the same manner as in Example 1.

### Example 3

An EC gel was prepared by heating at 90° C. for about 30 minutes in the same manner as in Example 1, except for using poly(dimethylaminoethyl methacrylate) as the polymer of a compound having a side chain containing a tertiary amine and N,N,N′,N′-tetra(trifluoromethanesulfonyl)-dodecane-1,12-diamine, which has two or more electrophilic substituents, as the crosslinking agent. The resulting EC gel was characterized as exhibiting a rotational torque of 512 mgf·cm. An EC element was fabricated using this EC gel in the same manner as in Example 1.

### Comparative Example 1

The EC gelling solution with the same specifications as in Example 1 was used for vacuum bonding in solution form without being gelled before vacuum bonding, and the thus formed element was heated at 90° C. for 60 minutes. Other conditions for the fabrication of the EC element were the same as in Example 1.

### Comparative Example 2

An EC gel was prepared in the same manner as in Example 1 except that the heating time for the EC gelling solution was reduced to about 6 minutes to inhibit gelation. The resulting EC gel was characterized as exhibiting a rotational torque of 176 mgf·cm. An EC element was fabricated using this EC gel in the same manner as in Example 1.

### Evaluation of EC Elements

The electrical and optical properties and display quality of the EC elements of Examples 1 to 3 and Comparative Examples 1 and 2 were evaluated. The results are presented in the Table. For the electrical and optical properties, the current density and optical density at an applied voltage of 0.7 V were compared. Display quality was evaluated based on whether or not unevenness could be detected in the range of optical density from 0 to 0.3 (about one stop).

The results of Comparative Examples 1 and 2 and Examples 1 and 2 show that the use of EC gels that had not gelled sufficiently and were closer to a solution form before vacuum bonding resulted in low current density and optical density and noticeable unevenness in display quality, whereas the use of EC gels that had gelled sufficiently resulted in high current density and optical density and uniform display in plane. In other words, the EC gels that exhibited a rotational torque of 500 mgf·cm or more as measured using an automatic apparatus for gelation time method A specified in JIS K 6910:2007 did not cause display defects or degradation in properties.

Also, the results of Example 3 show that even though the polymer and the crosslinking agent were changed, display defects or degradation in properties did not occur when the rotational torque was in the above-specified range.

TABLE

| | | Crosslinking | EC gel rotational | Current density | Optical | Display |
|---|---|---|---|---|---|---|
| | Polymer | agent | torque (mgf · cm) | (mA/cm²) | density | quality |
| Example 1 | P4VP | C6TFSA | 572 | 1.3 | 0.91 | Good |
| Example 2 | P4VP | C6TFSA | 880 | 1.2 | 0.94 | Good |
| Example 3 | PDMEMA | C12TFSA | 512 | 1.3 | 0.89 | Good |
| Comparative | P4VP | C6TFSA | N/A | 0.4 | 0.21 | Poor |
| Example 1 | | | | | | |
| Comparative | P4VP | C6TFSA | 176 | 1 | 0.54 | Poor |
| Example 2 | | | | | | |

The polymers and crosslinking agents presented in the Table are as follows:
P4VP: Poly(4-vinylpyridine)
PDMEMA: Poly(dimethylaminoethyl methacrylate)
C6TFSA: N,N,N′,N′-tetra(trifluoromethanesulfonyl)-hexane-1,6-diamine
C12TFSA: N,N,N′,N′-tetra(trifluoromethanesulfonyl)-dodecane-1,12-diamine

The present disclosure can achieve an EC element that has both high reliability and high responsivity with a simple manufacturing process by manufacturing an EC element including an EC layer made of an ionic chemical gel by a vacuum bonding method. Thus, a dimming element, a dimming film, a dimming window, and the like that are excellent in element performance and cost efficiency can be provided.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-037053 filed Mar. 11, 2024, which is hereby incorporated by reference herein in its entirety.

What is claimed is:

1. An electrochromic element comprising:
a first electrode;
a second electrode; and
an electrochromic layer disposed between the first electrode and the second electrode, the electrochromic layer containing at least one electrochromic compound,
wherein the electrochromic layer is a gel layer containing a crosslinked product of a dimer or higher polymer of a compound having a side chain containing a tertiary amine or a cyclic imine.

2. The electrochromic element according to claim 1, wherein the electrochromic layer exhibits a rotational torque of 500 mgf·cm or more as measured using an automatic apparatus for gelation time method A specified in JIS K 6910:2007.

3. The electrochromic element according to claim 1, wherein the electrochromic layer contains a plurality of electrochromic compounds.

4. The electrochromic element according to claim 3, wherein the plurality of electrochromic compounds include an anodic electrochromic compound and a cathodic electrochromic compound.

5. The electrochromic element according to claim 1, wherein the dimer or higher polymer is poly(4-vinylpyridine) or poly(dimethylaminoethyl methacrylate).

6. A method for manufacturing an electrochromic element that includes a first electrode, a second electrode, and an electrochromic layer disposed between the first electrode and the second electrode and containing at least one electrochromic compound, the method comprising:
preparing an electrochromic gel containing at least one electrochromic compound, a solvent, and a crosslinked product of a dimer or higher polymer of a compound having a side chain containing a tertiary amine or a cyclic imine;
forming a seal pattern surrounding a region to be filled with the electrochromic gel on the first electrode;
placing the electrochromic gel in the region surrounded by the seal pattern on the first electrode and then reducing pressure in the region surrounded by the seal pattern; and
bonding the first electrode and the second electrode together under the reduced pressure.

7. The method for manufacturing the electrochromic element according to claim 6, wherein the electrochromic gel exhibits a rotational torque of 500 mgf·cm or more as measured using an automatic apparatus for gelation time method A specified in JIS K 6910:2007.

8. The method for manufacturing the electrochromic element according to claim 6, wherein the electrochromic gel is formed by gelling an electrochromic gelling solution containing the at least one electrochromic compound, the solvent,
the dimer or higher polymer of the compound having the side chain containing the tertiary amine or the cyclic imine, and a crosslinking agent by heating.

9. The method for manufacturing the electrochromic element according to claim 6, wherein the at least one electrochromic compound includes a plurality of electrochromic compounds.

10. The method for manufacturing the electrochromic element according to claim 9, wherein the plurality of electrochromic compounds include an anodic electrochromic compound and a cathodic electrochromic compound.

11. The method for manufacturing the electrochromic element according to claim 6, wherein the dimer or higher polymer is poly(4-vinylpyridine) or poly(dimethylaminoethyl methacrylate).

12. An optical filter comprising:
the electrochromic element according to claim 1; and
a transistor connected to the electrochromic element.

13. A lens unit comprising:
the optical filter according to claim 12; and
an imaging optical system including a plurality of lenses.

14. An imaging device comprising:
the optical filter according to claim 12; and
a light-receiving element configured to receive light passing through the optical filter.

15. A window component comprising:
the electrochromic element according to claim 1; and
a transistor connected to the electrochromic element.

16. An electrochromic mirror comprising:
the electrochromic element according to claim 1; and
a reflection member disposed inside or outside the electrochromic element.
